(19) United States
(12) Patent Application Publication
(10) Pub. No.: US 2011/0231342 A1
(43) Pub. Date: Sep. 22, 2011

(54) ELECTRICITY USAGE PLANNER

(75) Inventors: Uwe D. SCHAIBLE, Ancaster (CA); Norman H. VON STYP-REKOWSKI, Oakville (CA)

(73) Assignee: MARLEX ENGINEERING INC., Ancaster (CA)

(21) Appl. No.: 13/052,492

(22) Filed: Mar. 21, 2011

Related U.S. Application Data
(60) Provisional application No. 61/315,484, filed on Mar. 19, 2010.

(51) Int. Cl. G06F 17/00

(52) U.S. Cl. 705/412

(57) ABSTRACT

A device for aiding in planning electricity usage in areas that use time of day electricity rates is provided. The device consists of a compact digital electricity cost indicator that displays the current time, day, date, applicable cost structure such as season, weekend, or holiday, and current cost of electricity, and a retractable electricity rate card for quick visualization of electricity rates throughout the day.

### CROSS-REFERENCE TO RELATED APPLICATIONS

This application claims the benefit of U.S. Provisional Patent Application No. 61/315,484, filed Mar. 19, 2010, which is hereby incorporated by reference in its entirety.

### FIELD OF TECHNOLOGY

The present document relates in general to a field of electricity usage, and more particularly, to an electricity usage planner.

### BACKGROUND

Many electricity producers are introducing new residential billing methods that vary the cost per kilowatt-hour (kWh) of electricity used based on the time of day it is used. The purpose behind this billing method is to curb electricity usage during peak hours and to shift this use to non-peak hours. However, in order for this to work, the consumers of electricity need to be aware of the cost of electricity at any point during the day as well as overall rate structures throughout the day so that they may better plan when to perform certain activities.

Therefore, there is provided an electricity usage planner which overcomes some disadvantages of the prior art.

### BRIEF DESCRIPTION OF THE DRAWINGS

The preferred embodiments will hereinafter be described in conjunction with the appended drawings provided to illustrate and not to limit the electricity usage device, wherein like designations denote like elements, and in which:

FIG. 1 illustrates a front view of an electricity usage planner in a clock mode, in accordance with one embodiment;

FIG. 2 illustrates a rear view of the electricity usage planner of FIG. 1;

FIG. 3 illustrates functional blocks of the electricity usage planner;

FIG. 4 illustrates an example layout of the electricity usage planner;

FIG. 5 illustrates a front view of an electricity usage planner in a clock mode, in accordance with a second embodiment;

FIG. 6 illustrates a front view of an electricity usage planner in a countdown mode, in accordance with the second embodiment;

FIG. 7 illustrates another layout of the electricity usage planner, in accordance with a second embodiment.

FIG. 8 illustrates a first page of an operational flowchart for the electricity usage planner; and

FIG. 9 illustrates a second page of the operational flowchart for the electricity usage planner.

### DETAILED DESCRIPTION OF THE INVENTION

The disclosure is directed at an electricity usage planner which acts as an aid in easy planning of future electricity use. On its display, the planner may provides information association with the current cost of electricity along with information concerning future costs so that user may discern this information with a simple glance at the planner.

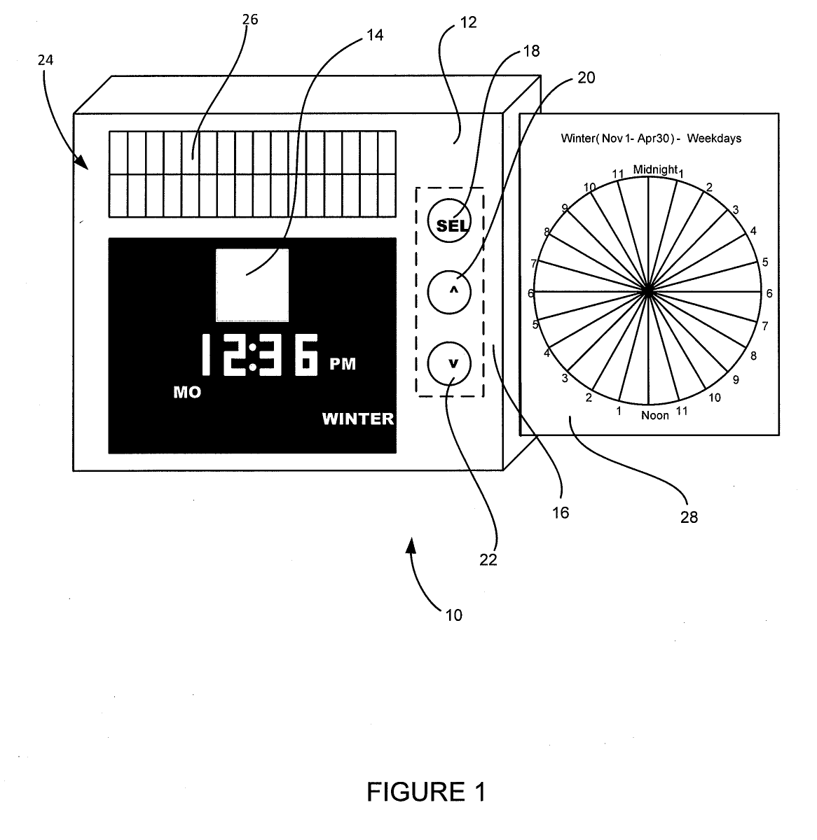

Turning to FIG. 1, a front perspective view of an electricity usage planner, or device (10) is shown. The electricity usage planner (10) includes a housing (12) which contains the electronics of the planner (10) as will be discussed in more detail below. The electronics assist to control a display (14), which is located in the housing (12) and displays information to the user or any individual who is looking at the planner (10). This information may contain general information such as the date and time as well as electricity information relating to electricity planning and usage and the current or future cost of electricity. Many types of displays are known and may be used including, but not limited to, a liquid crystal display (LCD), an organic light-emitting diode (OLED) display, or a light emitting diode (LEDs) display. The planner (10) may also include a set of buttons (16) or other input mechanisms such as switches or touchpads to allow for user control of the planner (10). The set of buttons (16) may include a select button (18), an up button (20), and a down button (22) to provide the user the capability for setting the time and date, editing tables, scrolling through menus, scrolling through different types of information and accessing different electricity information. Other buttons and controls are contemplated such as for entering settings or for controlling the operation of the planner (10).

In the current embodiment, the planner (10) is powered by a power source (24) such as a solar cell (26) which may provide a means for powering the planner from the ambient light in its environment. Alternatively, the planner may be powered by a battery, plugged into a wall outlet, or a combination of these methods. Other means of powering the electronics may also be applied in conjunction with, or in lieu of, those disclosed within.

An electricity rate card (28) provides a colored chart of the electricity rates throughout the day for the current season. However, to read the card, a user must be close to the card and cannot simply glance at the card for the usage or electricity information. Although shown in an extended position, the card (28) may be retracted into the housing (12) for compact storage. When necessary, It may be removed and replaced by another card for different seasons or whenever different usage rates apply or are implemented.

The colored chart on the electricity rate card (28) typically utilizes an analog 24 hour clock format with the circumference marked in 1 hour graduations. Each of the 24 1-hour sectors of the circular chart are filled with the color corresponding to the electricity rate for that specific hour segment. In one embodiment, green is used to represent an off-peak or low cost electricity rate, amber is used to represent a mid-peak or medium electricity rate, and red is used to represent an on-peak or high electricity rate.

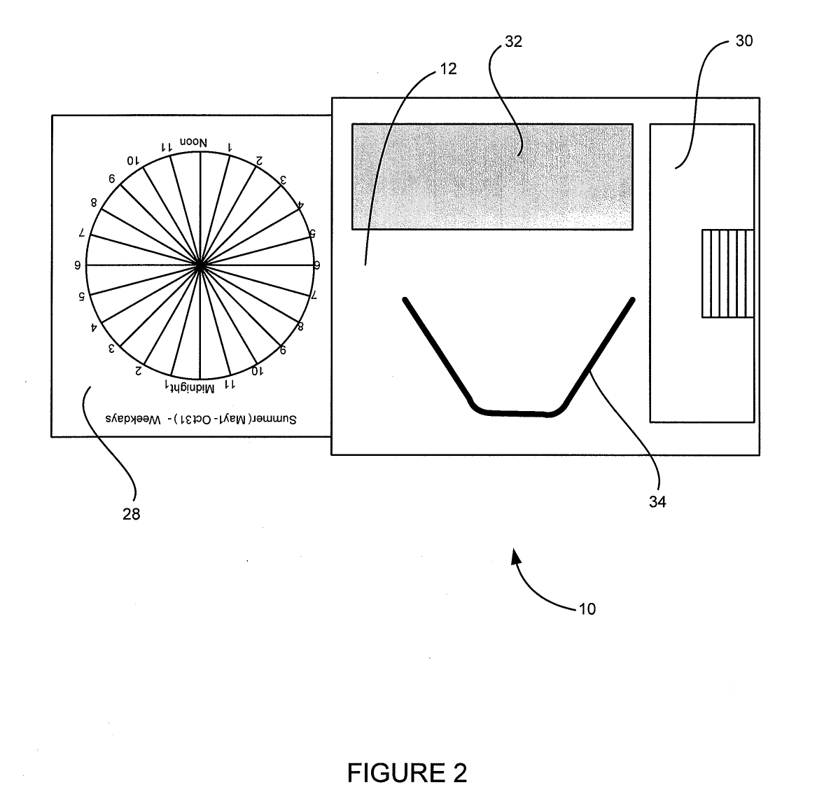

FIG. 2 illustrates a rear view of the electricity usage planner (10) of FIG. 1. The reverse side of the electricity rate card (28) is shown with electricity rates for a different season (summer) than the season (winter) shown on the opposite side of the card. A compartment door (30) provides access to a battery compartment for the insertion of a single or plurality of batteries that provide a power source (24) for powering the device. The planner (10) may also include a mounting apparatus such as magnetic strip (32) which provides a non-permanent apparatus for attaching the device to a magnetic metallic surface such as a refrigerator door. Other means of mounting such as, but not limited to, mounting holes for screws or separate clip on brackets are also contemplated. A flip out stand (34) provides an apparatus for propping up the device on a horizontal surface for easy viewing.

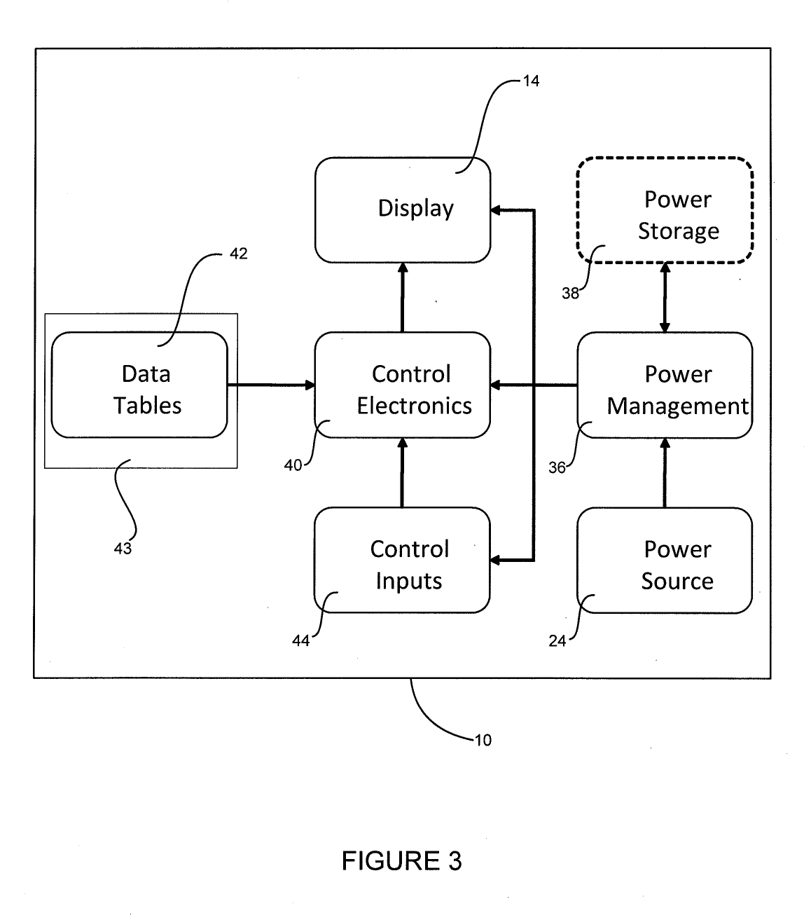

FIG. 3 provides a schematic diagram of the electricity usage planner (10). The power source (24) comprises one or more sources of electricity including, but not limited to, batteries, solar cells, or wall adapter to provide electrical power to the power management circuitry (36) and other components within the planner (10). The power management circuitry (36) may regulate and control the power supplied by the power source (24) to the rest of the parts of the planner (10). If an intermittent power source (24) is used then the power management circuitry (36) may store excess power from the power source (24) in an optional power storage circuit (38) for use when the intermittent power source is unavailable.

Control electronics (40) control the operation of the planner (10) and may contain an oscillator circuit for timekeeping. Implementation of the function of the control electronics (40) may be in many ways and such implementations include, but are not limited to, microcontrollers, hardwired circuits, application-specific integrated circuits (ASIC) and field-programmable gate arrays (FPGA). The control electronics (40) may retrieve and use electricity cost information stored in a set of data tables (42) in conjunction with the date and time information and may display the current cost of electricity on the display (14). In other words, the information that is provided on the rate card (28) may be stored in the data tables (42) and based on the time of day, the electricity rate may be reflected on the display. The data tables (42) are preferably pre-programmed in non-volatile memory (43) and contain information, such as electricity cost information, to derive the time dependent cost of electricity for the jurisdiction (State, Province, Power Authority) applicable to where the electricity usage planner (10) is being used. The non-volatile memory (43) used to store the data tables (42) may be comprised of a type that can be modified, allowing modification of the data tables (42), such as by the end user. Control inputs (44) to the control electronics (40) allow the user to perform functionality such as setting the date and time or editing the data tables (42), and may control other functions such as usage jurisdiction, time dependent cost, contrast of the display (14), or selection of the information to be displayed. The control inputs (44) may be implemented or associated with the set of buttons (16) or a communications interface port such as a USB, serial, Ethernet or other type of port.

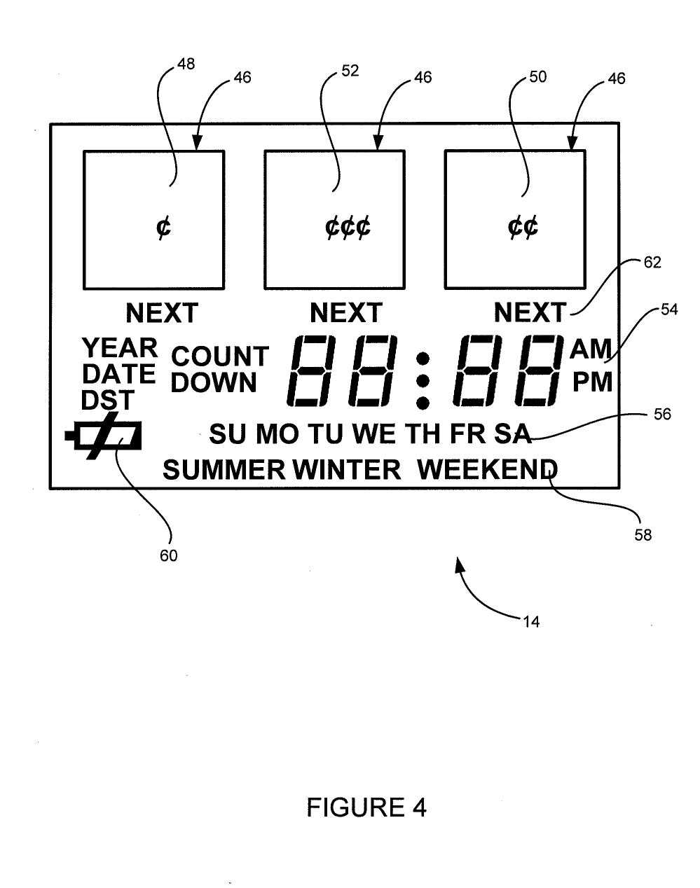

FIG. 4 illustrates a possible layout of a display (14), more specifically an LCD for use with an embodiment of the electricity usage planner. In one embodiment, the display (14) is a positive twisted nematic (TN) reflective display with colored filters, which gives color to certain areas of the display. Other LCD configurations such as negative TN reflective or split negative/positive TN reflective may be used. While it is preferred that no backlight is used in order to reduce the power consumption of the display (14) or planner (10), a backlight may be used depending on the manufacturer's design.

In operation, there are various ways to indicate the cost and consumption of power or electricity, however, in the preferred embodiment, green, yellow or amber, and red are used to denote low cost (green), medium cost (yellow or amber), and high cost (red) for electricity. The display of these colored areas may be augmented with further indication of the rate as an aid to users that may suffer from color blindness. In the layout shown in FIG. 4, the display (14) has a set of large, easily visible, colored areas (46) which allows the cost of electricity to be determined at a glance. These areas (46) may comprise a first, or green, area (48), a second, or yellow, area (50), and a third, or red, area (52). These areas may also contain high contrast printing or indicia that is viewable by colorblind users that indicates the cost of electricity. The embodiment shown in FIG. 4 has a single cent symbol in the green area (48), two cent symbols in the yellow area (50), and three cent symbols in the red area (52). These colored areas of the display (46) provides areas to display the current cost of electricity (low, medium, and high respectively) when illuminated. The electricity rate card (28) may use the same colors and printing to show the cost of electricity at various times throughout the day applicable to where the electricity usage planner is being used. The display (14) may include a general information area (54) which may show the current time and if daylight savings time is in effect. Other information may also be displayed when the user requests the information by clicking the buttons (16). The general information area (54) may also display the date, or the year, or the time countdown until the next electricity rate change or a combination of this information. A day area (56) may show the current day of the week. A season/weekend area (58) may display the current season for which the electricity costs are displayed or if special rates such as weekend or holiday rates apply. A low battery icon (60) may indicate that the power level of the set of batteries is low and should be replaced if batteries are being used to power the planner (10). A next rate area (62) used in conjunction with the green area (48), yellow area (50), and red area (52) may display the electricity cost after the next electricity rate change. The next portion may be illuminated to allow a user to quickly glance at the planner to understand the future cost of electricity. Other display fields are possible and the above-described areas may be modified or deleted depending on the size and shape of the display (14).

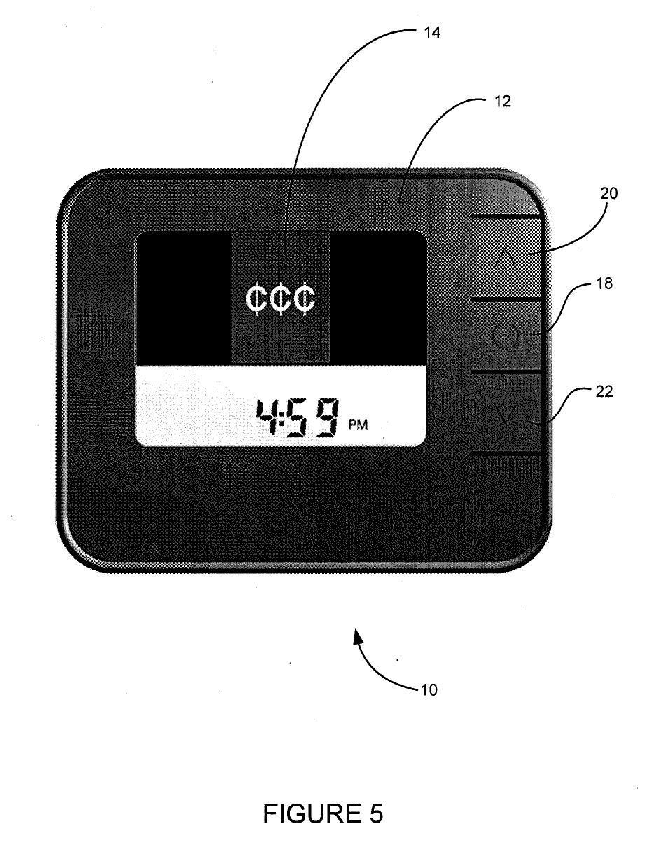

FIG. 5 is a schematic diagram of a planner with the display showing the time and the coloured areas reflecting that the cost of electricity is currently high as reflected by the colour and the number of cent symbols.

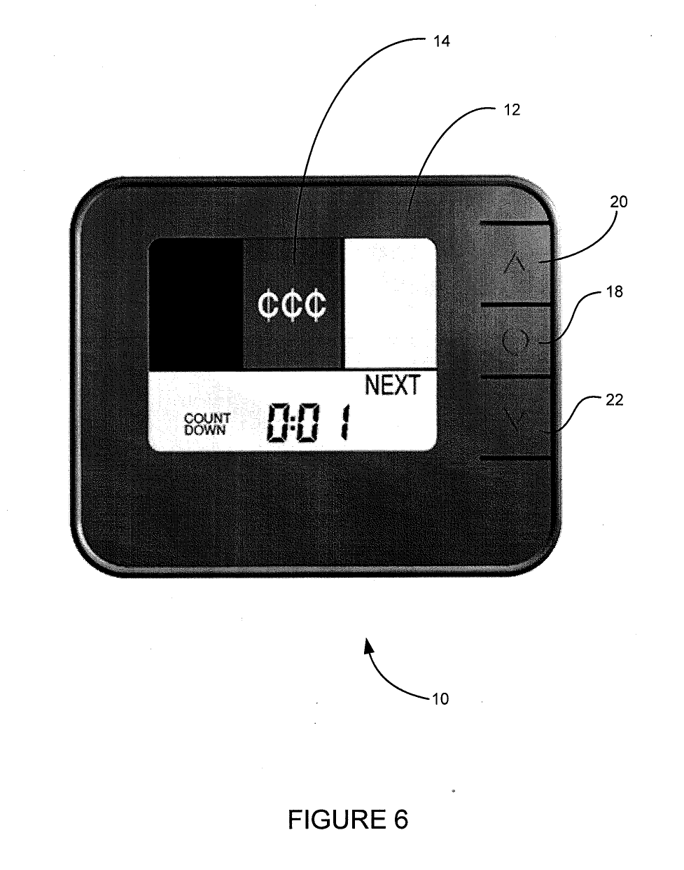

FIG. 6 is a schematic diagram of a planner with the display showing a countdown to the next electricity cost cycle in 1 minute from the current high cost range to the next, or medium, range as reflected by the colour of the area and the cent indicia symbols.

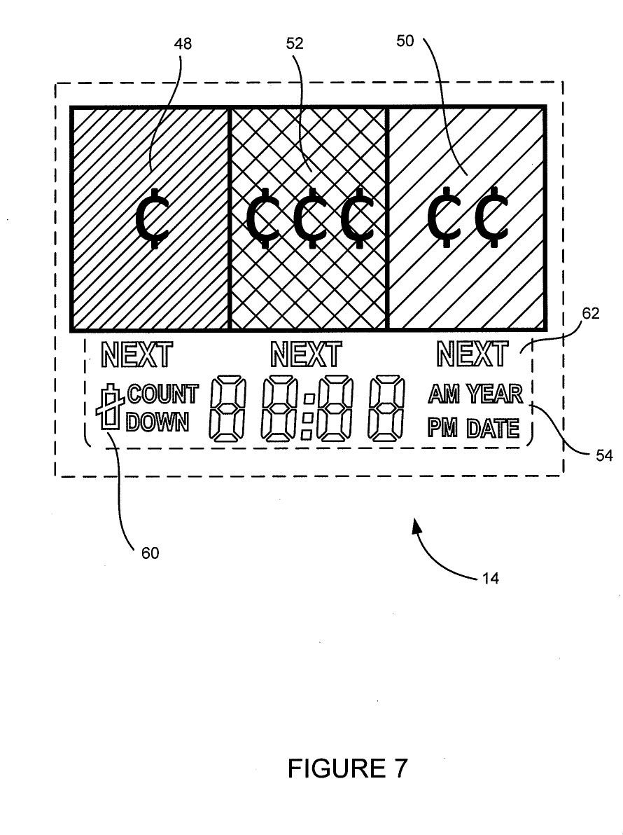

FIG. 7 is a schematic diagram of another embodiment of how the display may be oriented. The display (14) includes the display areas (46) including the three coloured areas ((48, 50 and 52). The display (14) also includes the general information area (54), a next rate area (62) and the low battery icon (60).

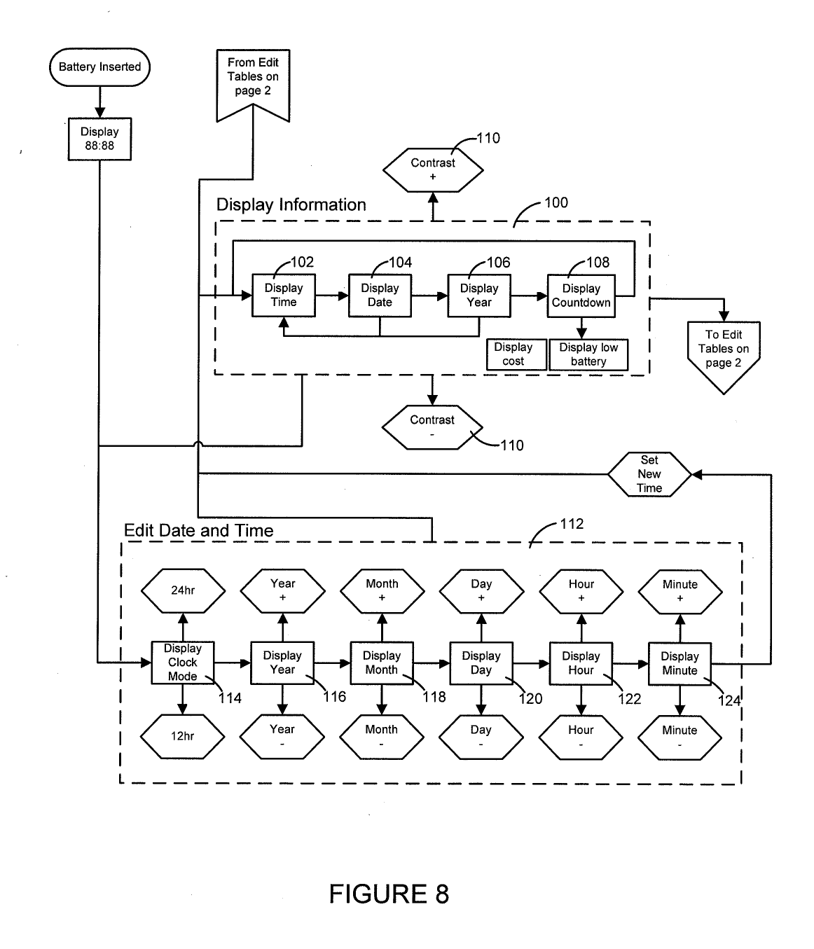

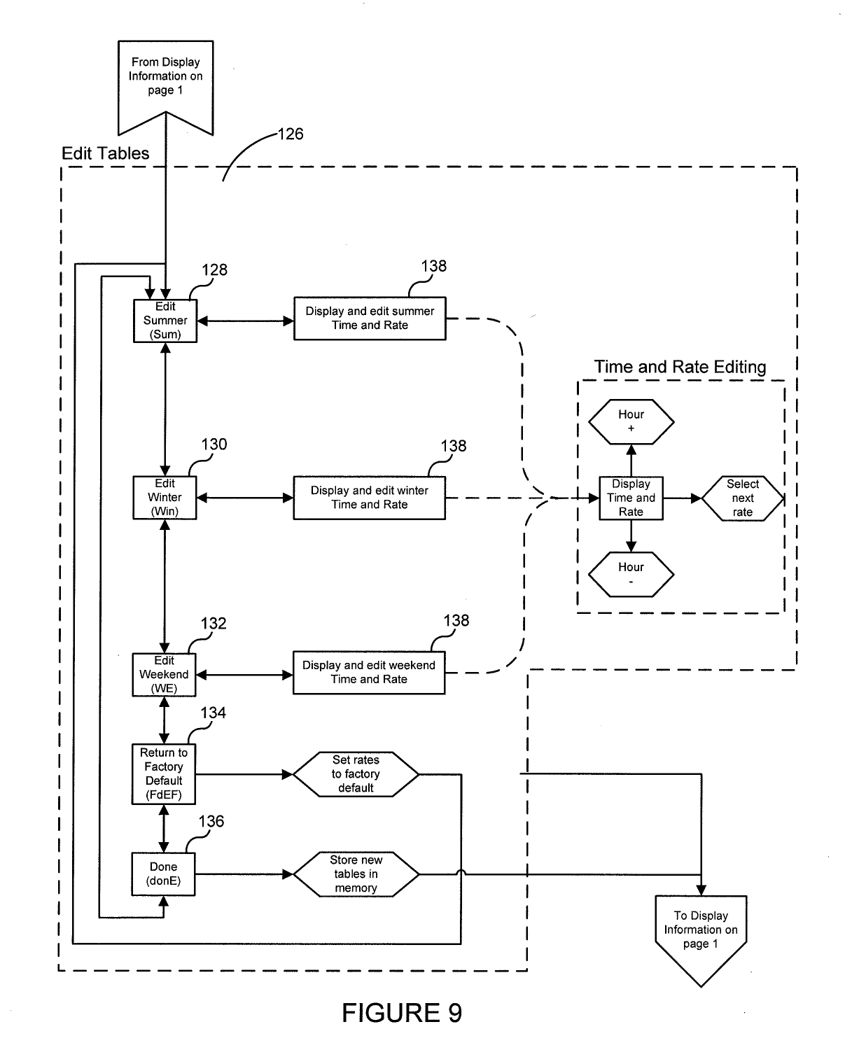

FIGS. 8 and 9 illustrate one embodiment of a method of operation of the electricity usage planner. When in display information mode (100), the planner (10) may display the current time in the general information area (54), the day in the day area (56), the season or weekend rate indication in the season/weekend area (58), the low battery indication (if applicable) through the low battery icon (60), and the current electricity cost through the flashing or illumination of one of the first area (48), second area (50), or red third area (52).

In this mode, there are several sub-modes. These may be cycled through using one of the buttons such as the select button (18). The sub-modes cycled through may include, but are not limited to, display time (102), display date (104), display year (106), and display countdown (108). The display date and display time sub-modes may revert to the display time sub-mode after a period of inactivity from the control inputs (44). The display countdown sub-mode may display the time until the next electricity rate change, or it may display the time until the electricity rate change to a certain target rate. In one embodiment, it may indicate the next electricity rate by solidly displaying one of the green area (48), yellow area (50), or red area (52) and displaying the “NEXT” symbol underneath that area as shown in the next rate area (62) such as for example in FIG. 6. In another embodiment, it may indicate the target electricity rate by solidly displaying one of the green area (48), yellow area (50), or red area (52).

In one implementation, the user may adjust the contrast (110) of the display by pressing the up button (20) to increase the contrast, and by pressing the down button (22) to decrease the contrast. Holding either button allows the user to cycle through the contrast levels in the appropriate direction. In one embodiment, by holding the select button (18), the user may enter an edit date and time mode. In another embodiment, by holding both the select button (18) and the up button (20), the user may enter an edit tables mode. If the select button (18), the up button (20), and the down button (22) are all depressed simultaneously, then the planner may revert to a power-up state. This reset may be useful if the device behaves erratically for any reason or stops responding.

When the edit date and time mode (112) is entered, the user may edit the date and time which is displayed on the device. This mode may be aborted by holding the select button (18) or by not activating any control inputs (44) for a period of time. The value to be edited may be shown by a flashing display. The user may increase the value being edited by one unit by depressing the up button (20) or increase the value quickly by depressing and holding the up button (20). The user may decrease the value being edited by one unit by depressing the down button (22) or decrease the value quickly by depressing and holding the down button (22). Once the desired value is obtained, the user may cycle to the next quantity to be adjusted by depressing the select button (18). Once the last editable value has been adjusted, the unit may return to display information mode. During the edit date and time mode, the following quantities may be adjusted in a pre-set order: 24 hour/12 hour mode (114), year (116), month (118), day of the month (120), hour (122), and minute (124). These quantities are shown in the general information area (54).

When the edit tables mode (126) is entered, the user may edit the electricity rate tables. This mode may be aborted by holding the select button (18) or by not activating any control inputs (44) for a period of time. When this mode is first entered, the menu sub-mode may be active. Pressing the up button (20) or the down button (22) may allow the user to cycle through the menu selections. The selections may include edit summer table (128), edit winter table (130), edit weekend table (132), revert to factory default (134), or done editing (136). The user may select a menu item by depressing the select button (18). Selecting the edit summer table, edit winter table, or edit weekend table option may bring the user to the editing time and rate sub-mode (138) for the selected table. In this mode the hour may be displayed in the general information area (54) and the rate for that hour may be displayed on the green (48), yellow (50), or red area (52). Depressing the up button (20) may increment the time. Incrementing the time from 11:00 PM may display “BACK”. From this point, depressing the select button (18) may bring the user back to the menu sub-mode. Depressing the up button when “BACK” is displayed, may display the time and rate at 12:00 AM. Depressing the down button (22) may decrement the time. Decrementing the time from 12:00 AM may display “BACK”. From this point, depressing the select button (18) may bring the user back to the menu sub-mode. Depressing the down button (22) when “BACK” is displayed, may display the time and rate at 11:00 PM. When a time and rate is shown, depressing the select button (18) may cycle through the different rates. Holding the up button (20) or the down button (22) may cycle quickly through the time in the appropriate direction. Selecting revert to factory default from the menu sub-mode may set the rates for all tables being edited back to the factory default values. The new values may not be made permanent at this point, and the change may still be aborted by the user if the edit tables mode is aborted. Once the “revert to factory default values” is selected, the user may be taken back to the edit summer table selection of the menu sub-mode. Selecting done editing may save the modified tables into the data tables (42) section of memory and return the user to the display information mode.

This describes one possible method of operation of the invention, and many variations of the number of buttons or other controls and possible methods of displaying the information will be obvious to those skilled in the art.

While the preferred embodiments have been illustrated and described, it will be clear that it is not limited to these embodiments. Numerous modifications, changes, variations, substitutions and equivalents will be apparent to those skilled in the art without departing from the spirit and scope.

What is claimed is:

1. An electricity usage planner comprising:
a general display area for displaying electricity cost information; and
a processor for controlling the information displayed on the display area;
wherein the processor updates the display area to reflect the electricity cost information based on time of day and cost of electricity.

2. The planner of claim 1 wherein the general display area includes a set of individual display areas.

3. The planner of claim 2 wherein the set of individual display areas include a low electricity cost display area, a medium electricity cost display area and a high electricity cost display area.

4. The planner of claim 3 wherein the low electricity cost display area is illuminated by a set of green lights.

5. The planner of claim 3 wherein the medium electricity cost display area is illuminated by a set of yellow lights.

6. The planner of claim 3 wherein the high electricity cost display area is illuminated by a set of red lights.

7. The planner of claim 3 wherein the low electricity cost display area includes a single cent sign.

8. The planner of claim 3 wherein the medium electricity cost display area is illuminated by a set of two cent signs.

9. The planner of claim 3 wherein the high electricity cost display area is illuminated by a set of three cent signs.

10. The planner of claim 1 further comprising a power source for powering the planner.

11. The planner of claim 1 further comprising a flip-out stand for supporting the planner.

12. The planner of claim 1 further comprising a magnetic strip.

13. The planner of claim 1 further comprising a set of buttons for controlling the display.

14. The planner of claim 13 wherein the set of buttons comprise:
an up button;
a down button; and
a select button.

15. A method of displaying electricity cost information comprising:
determining a time of day;
retrieving cost of electricity associated with the time of day; and
displaying cost of electricity.

16. The method of claim 15 further comprising:
determining time until change in cost of electricity; and
displaying a countdown of the time until change.

17. The method of claim 15 further comprising:
determining time until change to lowest cost of electricity; and
displaying a countdown of the time until change to lowest cost of electricity.

18. The method of claim 15 further comprising:
determining time until change to highest cost of electricity; and
displaying a countdown of the time until change to highest cost of electricity.
